(19) United States
(12) Patent Application Publication
(10) Pub. No.: US 2017/0212645 A1
(43) Pub. Date: Jul. 27, 2017

(54) DISPLAY DEVICE AND DISPLAY METHOD FOR DISPLAY DEVICE

(71) Applicant: Panasonic Intellectual Property Management Co., Ltd., Osaka (JP)

(72) Inventors: SHOTA NAKAJIMA, Kyoto (JP); YASUHIRO BAN, Saitama (JP); NAOKI YAMASAKI, Shiga (JP); AKIO SHINDO, Shiga (JP)

(21) Appl. No.: 15/409,916

(22) Filed: Jan. 19, 2017

(30) Foreign Application Priority Data
Jan. 26, 2016 (JP) 2016-012586

(51) Int. Cl. G06F 3/0482

(52) U.S. Cl. CPC G06F 3/0482; G06F 3/04817

(57) ABSTRACT

When a user touches a menu on a first hierarchy, a display device shows another menu on a second hierarchy near the touched menu. The user can make a selection on the second hierarchy by successively tracing his or her finger on the menu on the second hierarchy. In a third hierarchy and subsequent hierarchies, still another menu on a corresponding hierarchy is shown near the selected menu on the previous hierarchy.

### BACKGROUND

1. Technical Field

The present disclosure relates to a display device capable of showing menus in a plurality of hierarchies, and a display method for the display device.

2. Description of the Related Art

Beverage dispensers capable of dispensing a beverage by allowing a user to freely select and combine favorite ingredients from a plurality of ingredient options have currently widely been provided in restaurants such as family restaurants.

Such beverage dispenser is capable of making, for example, lemon flavored cola by mixing cola and lemon, vanilla flavored cola by mixing cola and vanilla, and a plurality of types of cola-based beverages.

Many Unexamined Japanese Patent Publications also propose technologies relating to such beverage dispensers.

Unexamined Japanese Patent Publication No. 2014-45721, for example, discloses a beverage dispenser which shows an operation procedure for making a cocktail on a display device.

This technology described in Unexamined Japanese Patent Publication No. 2014-45721 shows a cocktail making procedure on a display unit, which helps a user to know how to make a cocktail. However, a plurality of operational icons that differ in shape might confuse a user who uses this display device for the first time.

### SUMMARY

The present disclosure provides a display device allowing a user to easily make entry operations for selecting a desired menu from a plurality of types of menus, and to freely combine the selected plurality of menus to obtain a desired combination, as well as provides a display method for the display device.

Specifically, a display device according to an exemplary embodiment of the present disclosure includes a display unit, a storage unit for storing a plurality of images to be shown on the display unit, and an input unit for accepting an entry operation for selecting at least one image from the plurality of images to be shown on the display unit. The display device according to one aspect of the exemplary embodiment of the present disclosure further includes a controller for selecting, from the plurality of images, based on an entry operation on the input unit, at least one image to be shown on the display unit, and for causing the display unit to show the selected at least one image. The storage unit further stores menu information including a plurality of hierarchies and a plurality of items respectively set in the plurality of hierarchies. The plurality of images includes images respectively corresponding to the plurality of items respectively set in the plurality of hierarchies included in the menu information. When the controller determines that any item is selected from a plurality of items set in an n-th hierarchy (n is a natural number) in the plurality of hierarchies, the controller causes the display unit to show an image corresponding to the item selected on the n-th hierarchy, in a mode indicating that the item is selected on the n-th hierarchy. The controller is further configured to cause the display unit to show images respectively corresponding to a plurality of items on a hierarchy lower than the n-th hierarchy, around the image corresponding to the item selected on the n-th hierarchy.

According to such a configuration, when a user makes, on the display device, entry operations for selecting desired items from menus on a plurality of hierarchies, and freely combining the selected plurality of items to obtain a desired combination, a time and effort for making settings can be reduced, thus the user can easily make entry operations. According to such a configuration, since contents (items) to subsequently be selected by the user will be shown on the display unit in a promptly, easily understandable manner, the user can easily recognize the subsequently selectable contents (items).

### BRIEF DESCRIPTION OF THE DRAWINGS

FIG. 1 is a perspective view of a beverage dispenser equipped with a display device according to one of first to seventh exemplary embodiments of the present disclosure;

FIG. 2 is a block diagram illustrating an internal configuration of the beverage dispenser equipped with the display device according to the one of the first to seventh exemplary embodiments of the present disclosure;

FIG. 3 is a view illustrating icons on a first hierarchy shown on a display device according to the first exemplary embodiment of the present disclosure;

FIG. 4 is a view illustrating icons on a second hierarchy shown on the display device according to the first exemplary embodiment of the present disclosure;

FIG. 5 is a view illustrating icons on a third hierarchy shown on the display device according to the first exemplary embodiment of the present disclosure;

FIG. 6 is a view illustrating a beverage ready-to-dispense screen shown on the display device according to the first exemplary embodiment of the present disclosure;

FIG. 7 is a view illustrating a beverage dispensing screen shown on the display device according to the first exemplary embodiment of the present disclosure;

FIG. 8 is a view illustrating a beverage dispensing completion screen shown on the display device according to the first exemplary embodiment of the present disclosure;

FIG. 9 is a flowchart illustrating operations of the beverage dispenser equipped with the display device according to the one of the first to seventh exemplary embodiments of the present disclosure;

FIG. 10 is a view illustrating a display screen shown on a touch panel of a display device according to the second exemplary embodiment of the present disclosure;

FIG. 11 is a view illustrating a display screen shown on a touch panel of a display device according to the third exemplary embodiment of the present disclosure;

FIG. 12 is a view illustrating a display screen shown on a touch panel of a display device according to the fourth exemplary embodiment of the present disclosure;

FIG. 13 is a view illustrating a display screen shown on a touch panel of a display device according to the fifth exemplary embodiment of the present disclosure;

FIG. 14 is a view illustrating another display screen shown on the touch panel of the display device according to the fifth exemplary embodiment of the present disclosure;

FIG. 15 is a view illustrating a display screen shown on a touch panel of a display device according to the sixth exemplary embodiment of the present disclosure; and

FIG. 16 is a view illustrating a display screen shown on a touch panel of a display device according to the seventh exemplary embodiment of the present disclosure.

### DETAILED DESCRIPTION

Exemplary embodiments of the present disclosure will now be described herein with reference to the drawings. However, the exemplary embodiments described below are not intended to limit the scope of the present disclosure.

A display device according to one aspect of the exemplary embodiments of the present disclosure includes a display unit, a storage unit for storing a plurality of images to be shown on the display unit, and an input unit for accepting an entry operation for selecting at least one image from the plurality of images to be shown on the display unit. The display device according to one aspect of the exemplary embodiments of the present disclosure further includes a controller for selecting, from the plurality of images, based on an entry operation on the input unit, at least one image to be shown on the display unit, and for causing the display unit to show the selected at least one image. The storage unit further stores menu information including a plurality of hierarchies and a plurality of items respectively set in the plurality of hierarchies. The plurality of images includes images respectively corresponding to the plurality of items respectively set in the plurality of hierarchies included in the menu information. When the controller determines that any item is selected from a plurality of items set in an n-th hierarchy (n is a natural number) in the plurality of hierarchies, the controller causes the display unit to show an image corresponding to the item selected on the n-th hierarchy, in a mode indicating that the item is selected on the n-th hierarchy. The controller is further configured to cause the display unit to show images respectively corresponding to a plurality of items on a hierarchy lower than the n-th hierarchy, around the image corresponding to the item selected on the n-th hierarchy.

According to such a configuration, when a user makes, on the display device, entry operations for selecting desired items from menus on a plurality of hierarchies, and freely combining the selected plurality of items to obtain a desired combination, a time and effort for making settings can be reduced, thus the user can easily make entry operations. According to such a configuration, since contents (items) to subsequently be selected by the user will be shown on the display unit in a promptly, easily understandable manner, the user can easily recognize the subsequently selectable contents (items).

A display device according to one aspect of the exemplary embodiments of the present disclosure may be configured such that, while a hierarchy lower than the n-th hierarchy is an (n+1)-th hierarchy in the plurality of hierarchies, when the controller determines that any image is selected from images respectively corresponding to a plurality of items on the (n+1)-th hierarchy, the controller causes the display unit to show the selected image, in a mode indicating that the image is selected. The display device according to one aspect of the exemplary embodiments of the present disclosure may be configured to further show images respectively corresponding to a plurality of items on an (n+2)-th hierarchy lower than the (n+1)-th hierarchy, around the image selected on the (n+1)-th hierarchy.

According to such a configuration, when a user makes entry operations for selecting desired items from menus on a plurality of hierarchies, and freely combining the selected plurality of items to obtain a desired combination, a time and effort for making settings can be reduced, thus the user can easily make entry operations. According to such a configuration, since contents (items) to subsequently be selected by the user will be shown on the display unit in a promptly, easily understandable manner, the user can easily recognize the subsequently selectable contents (items).

A display device according to one aspect of the exemplary embodiments of the present disclosure may be configured such that, when the controller determines that any image is selected, through an entry operation on the input unit, from images respectively corresponding to the plurality of items set in the n-th hierarchy in the plurality of hierarchies, the controller causes the display unit to show the selected image, in a mode indicating that the image is selected. The display device according to one aspect of the exemplary embodiments of the present disclosure may be configured such that the controller causes the display unit to show images respectively corresponding to the plurality of items on the (n+2)-th hierarchy lower than the n-th hierarchy, around the image selected on the n-th hierarchy. The display device according to one aspect of the exemplary embodiments of the present disclosure may be configured such that, when the controller determines that any image is selected, through an entry operation on the input unit, from the images respectively corresponding to the plurality of items on the (n+2)-th hierarchy, the controller automatically selects a predetermined item on the (n+1)-th hierarchy, and causes the display unit to show an image corresponding to the predetermined item. In this case, the predetermined item on the (n+1)-th hierarchy may be associated with the item corresponding to the image selected on the (n+2)-th hierarchy, be set beforehand, and be stored in the storage unit.

According to such a configuration, since a user can select a desired item with a less number of operations, a time and effort for making entry operations can be reduced. The user can therefore easily make entry operations for settings and other purposes. According to such a configuration, the user further can promptly and easily recognize subsequently selectable contents (items).

With a display device according to one aspect of the exemplary embodiments of the present disclosure, the predetermined item to automatically be selected on the (n+1)-th hierarchy by the controller may be set beforehand and stored in the storage unit.

According to such a configuration, a user is able to select a desired item with less effort. A time and effort can therefore be reduced for making entry operations for selecting desired items from a plurality of items, and combining the selected items to obtain a desired combination.

In the display device according to the present disclosure, the predetermined item to automatically be selected by the controller on the (n+1)-th hierarchy may be associated with the item corresponding to the image selected on the n-th hierarchy, and the item corresponding to the image selected on the (n+2)-th hierarchy, be set beforehand, and be stored in the storage unit.

According to such a configuration, a user is not required to make an entry operation on each hierarchy, thus an entry operation for selecting an item on the (n+1)-th hierarchy can be omitted. The hierarchy from which an entry operation is omitted is not limited to the (n+1)-th hierarchy, but other hierarchies may be omitted. A user can therefore select and combine a plurality of items with a less number of entry operations. A time and effort can therefore be reduced for making entry operations for selecting desired items from a plurality of items, and combining the selected items to obtain a desired combination.

A display device according to one aspect of the exemplary embodiments of the present disclosure may be configured such that images respectively corresponding to a plurality of items on a hierarchy lower than the n-th hierarchy are separated into a plurality of pages and stored in the storage unit, and the plurality of pages are each switched through a predetermined entry operation on the input unit, and shown on the display unit.

According to such a configuration, even a plurality of items available on a single hierarchy can easily and promptly be shown on the display unit by switching each of a plurality of pages including the plurality of items. A user therefore can promptly recognize, through easy operations, all images corresponding to a plurality of items on a single hierarchy, on the display unit having a limited area. A time and effort can also be reduced for making entry operations for selecting desired items from a plurality of items, and combining the selected items to obtain a desired combination.

A display device according to one aspect of the exemplary embodiments of the present disclosure may be configured such that the controller causes the display unit to show, in different modes, an image corresponding to an item determined by the controller as selected through an entry operation on the input unit, and images corresponding to items determined by the controller as not selected.

According to such a configuration, a user can easily determine, on the display unit, which items are selectable. The user can therefore easily make operations for settings and other purposes.

A display device according to one aspect of the exemplary embodiments of the present disclosure may be configured such that images respectively corresponding to a plurality of items are shown with icons or messages on the display unit. The display device according to one aspect of the exemplary embodiments of the present disclosure may be configured such that an icon or message corresponding to an item selected from the plurality of items on the n-th hierarchy may be shown, on the display unit, adjacent to or touched with at least parts of images of icons or messages regarding a plurality of items on a hierarchy lower than the n-th hierarchy.

According to such a configuration, a user can promptly and easily recognize, on the display unit, a selected item and items to be selected, from a plurality of items respectively set in a plurality of hierarchies. The user can therefore easily and promptly make entry operations when selecting desired items from the plurality of items on the plurality of hierarchies.

A display device according to a display method for a display device, according to one aspect of the exemplary embodiments of the present disclosure, includes a display unit, a storage unit for storing a plurality of images to be shown on the display unit, and an input unit for accepting an entry operation for selecting at least one of the plurality of images to be shown on the display unit. The display device according to the display method for the display device, according to one aspect of the exemplary embodiments of the present disclosure, further includes a controller for selecting, from the plurality of images, based on an entry operation on the input unit, at least one image to be shown on the display unit, and for causing the display unit to show the selected at least one image. In the display device according to the display method for the display device, according to one aspect of the exemplary embodiments of the present disclosure, the storage unit stores menu information including a plurality of hierarchies and a plurality of items respectively set in the plurality of hierarchies, where the plurality of images includes images respectively corresponding to the plurality of items respectively set in the plurality of hierarchies included in the menu information.

A display method for a display device, according to one aspect of the exemplary embodiments of the present disclosure, includes, with a display device configured as described above, a step of showing, on the display unit, the images respectively corresponding to the plurality of items set in the n-th hierarchy (n is a natural number) in the plurality of hierarchies included in the menu information. The display method for the display device, according to one aspect of the exemplary embodiments of the present disclosure, includes a step of showing, on the display unit, an image selected, through an entry operation on the input unit, from the images respectively corresponding to the plurality of items on the n-th hierarchy to be shown on the display unit, in a mode indicating that the image is selected. The display method for the display device, according to one aspect of the exemplary embodiments of the present disclosure, further includes a step of showing images respectively corresponding to a plurality of items on a hierarchy lower than the n-th hierarchy, around the selected image.

According to such a method, when a user makes entry operations for selecting desired items from menus on a plurality of hierarchies, and freely combining the selected plurality of items to obtain a desired combination, a time and effort for entry operations for settings and other purposes by the user can be reduced, thus the user can easily make entry operations. The user can also promptly and easily recognize, on the display unit, subsequently selectable contents (items).

A display method for a display device, according to one aspect of the exemplary embodiments of the present disclosure, may include, when the (n+1)-th hierarchy in the plurality of hierarchies is lower than the n-th hierarchy, a step of showing, on the display unit, the images respectively corresponding to the plurality of items on the (n+2)-th hierarchy lower than the (n+1)-th hierarchy, around an image corresponding to an item selected on the (n+1)-th hierarchy.

According to such a method, a user can promptly and easily recognize items subsequently selectable on the display unit, thus the user can easily and promptly make entry operations for settings and other purposes.

A display method for a display device, according to one aspect of the exemplary embodiments of the present disclosure, may further include a step of automatically showing, when any image is selected from the images respectively corresponding to the plurality of items set in the (n+2)-th hierarchy, a predetermined item on the (n+1)-th hierarchy, on the display unit.

According to such a method, since the user is able to select desired items with a less number of entry operations, thus a time and effort can be reduced for making entry operations for selecting desired items from a plurality of items on a plurality of hierarchies.

A display method for a display device, according to one aspect of the exemplary embodiments of the present disclosure, may further include a step of showing the images respectively corresponding to the plurality of items set on the (n+1)-th hierarchy lower than the n-th hierarchy, around an image corresponding to the item selected on the n-th hierarchy, and a step of, by separating the images respectively corresponding to the plurality of items on the (n+1)-th hierarchy into a plurality of pages, switching and showing, on the display unit, each of the plurality of pages, based on a predetermined entry operation on the input unit.

According to such a method, the plurality of pages including the plurality of items to be shown on the display unit can be easily and promptly shown on the display unit by switching the pages. A user can therefore promptly recognize, through easy operations, all images corresponding to a plurality of items on a single hierarchy, on the display unit having a limited area. According to such a method, a time and effort can also be reduced for making entry operations for selecting desired items from a plurality of items, and combining the selected items to obtain a desired combination.

### First Exemplary Embodiment

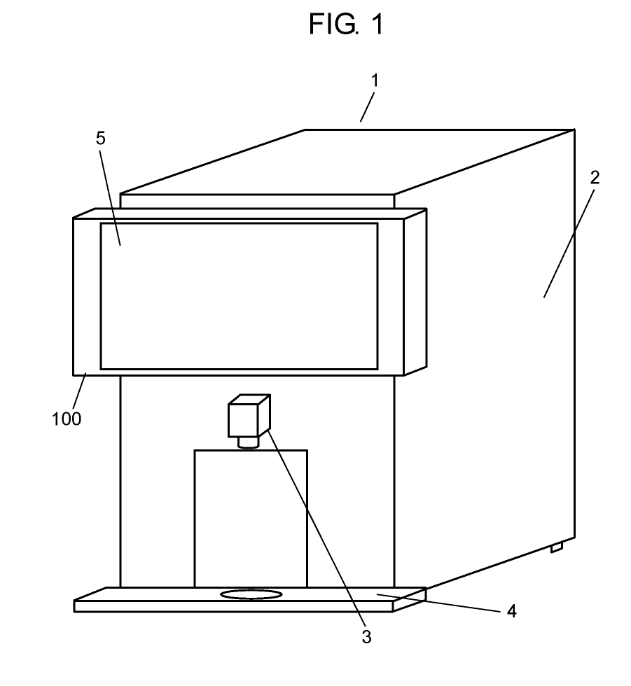

FIG. 1 is an external view of a beverage dispenser equipped with a display device according to one of first to seventh exemplary embodiments of the present disclosure. In beverage dispenser 1 equipped with display device 100 according to the one of the first to seventh exemplary embodiments of the present disclosure, as shown in FIG. 1, beverage dispensing port 3 and tray 4 for placing a cup are provided to housing 2 containing a plurality of types of beverage syrup. Display device 100 for showing a beverage menu is provided at an upper portion of housing 2.

Display device 100 includes a display unit for showing a plurality of images in relation to selection of a beverage menu, storage unit 7 for storing the plurality of images to be shown on the display unit, and an input unit for accepting an entry operation for selecting at least one of the plurality of images to be shown on the display unit. The input unit and the display unit may be formed separately, or may be formed integrated so as to have both functions of the input unit and the display unit, like a touch panel or a similar device.

In this exemplary embodiment, touch panel 5 includes both functions of the input unit and the display unit. In the present disclosure, a description “making an entry operation on touch panel 5” means that the entry operation is made on the input unit of display device 100, while a description “showing an item or an image on touch panel 5” means that the item or the image is shown on the display unit of display device 100.

Display device 100 according to this exemplary embodiment further includes controller 6 for selecting, from a plurality of images, based on an entry operation on the input unit, at least one image to be shown on the display unit, and for causing the display unit to show the selected at least one image.

Beverage dispenser 1 equipped with display device 100 according to this exemplary embodiment is configured, as shown in FIG. 1, when a user puts a cup on tray 4, selects a beverage menu on touch panel 5 of display device 100, and gives an instruction for dispensing a beverage, to dispense the selected beverage from beverage dispensing port 3.

Display device 100 according to this exemplary embodiment is configured, when a user makes entry operations on touch panel 5 of display device 100, such as touching at least one of a plurality of images shown on touch panel 5, to select items for producing a desired beverage by combining a plurality of items such as a beverage menu and a cup size. Specifically, display device 100 according to this exemplary embodiment is configured such that, for example, on each of a plurality of beverage menu hierarchies such as “base beverage” and “flavor mix,” and a hierarchy such as “cup size,” desired items can respectively be selected, for example, items of cola as “base beverage,” lemon as “flavor mix,” and an size M cup as “cup size.” Beverage dispenser 1 equipped with display device 100 according to this exemplary embodiment is further configured, when a user selects images corresponding to desired items on touch panel 5 of display device 100, to provide a user's favorite beverage poured with a user's desired cup size.

In display device 100 according to this exemplary embodiment, storage unit 7 further stores menu information including a plurality of hierarchies and a plurality of items respectively set in the plurality of hierarchies. The plurality of images stored in storage unit 7 includes images respectively corresponding to the plurality of items respectively set in the plurality of hierarchies included in the menu information. A base beverage menu, for example, is set as a first hierarchy in the plurality of hierarchies. The first hierarchy is set with, as a plurality of items on the first hierarchy, i.e. the base beverage menu; cola, cider, tea, root beer, oolong tea, tonic water, and other beverages.

As a second hierarchy in the plurality of hierarchies, for example, a flavor mix menu is set for mixing with an item selected from the base beverage menu. The second hierarchy is set with, as a plurality of items on the second hierarchy, i.e. the flavor mix menu; grape, lemon, orange, and other flavors.

As a third hierarchy in the plurality of hierarchies, for example, cup sizes are set. The third hierarchy is set with, as a plurality of items on the third hierarchy, such as, size S, size M, and size L.

In this exemplary embodiment, the second and third hierarchies are referred to as lower hierarchies that are lower than the first hierarchy, while the second and first hierarchies are referred to as upper hierarchies that are higher than the third hierarchy.

The hierarchies are not limited to the first to third hierarchies, but may include an n-th hierarchy (n is a natural number). Hierarchies lower than the n-th hierarchy are referred to as an (n+1)-th hierarchy and an (n+2)-th hierarchy, for example.

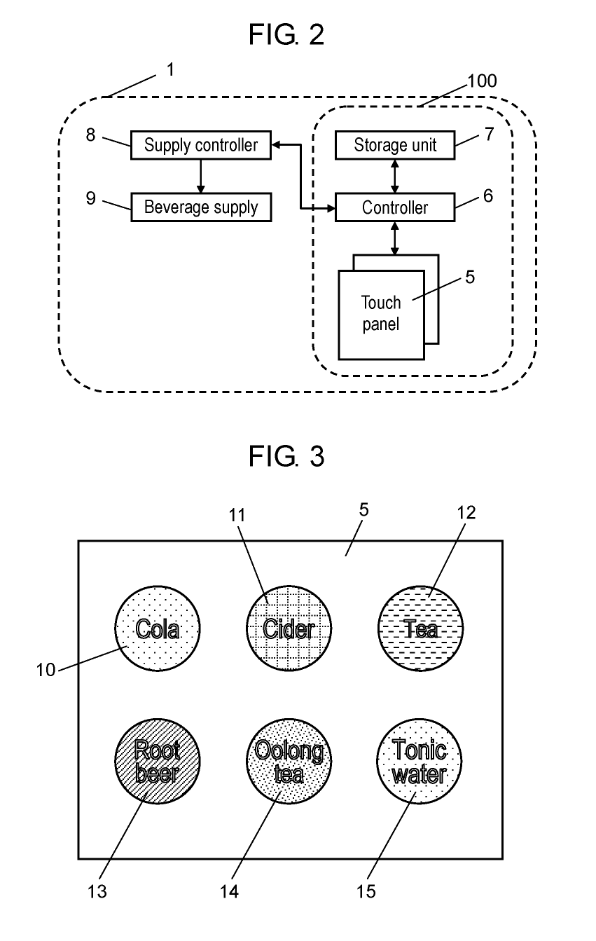

FIG. 2 is a block diagram illustrating an internal configuration of a beverage dispenser equipped with a display device according to one of the first to seventh exemplary embodiments of the present disclosure. In FIG. 2, controller 6 is configured by, for example, a microcomputer such as a Central Processing Unit (CPU) to control operations of display device 100 and circuits in beverage dispenser 1.

Touch panel 5 of display device 100 is configured by, for example, an electrostatic or pressure sensitive touch panel, and includes a function of an input unit for accepting an entry operation made by a user, and a function of a display unit for showing images such as characters and pictures, based on information entered by the user.

Storage unit 7 of display device 100 is configured by a nonvolatile memory such as flash memory to store software to be executed by controller 6 and information such as various parameters. Storage unit 7 also stores, as described above, menu information including a plurality of hierarchies and a plurality of items respectively set in the plurality of hierarchies. Specifically, as the plurality of hierarchies, storage unit 7 stores menu information such as the base beverage menu on the first hierarchy, the flavor mix menu on the second hierarchy, cup sizes on the third hierarchy, and other items. As the plurality of items, storage unit 7 stores items such as cola and cider set in the base beverage menu on the first hierarchy, items such as grape and lemon set in the flavor mix menu on the second hierarchy, and items such as size S and size M set in the cup sizes on the third hierarchy. Storage unit 7 further stores, as described later, information on icons corresponding to the items, information on various messages to be shown on touch panel 5, predetermined items set by default, images, and other data.

Beverage supply 9 shown in FIG. 2 also includes a pump for dispensing a beverage and other liquids. Supply controller 8 shown in FIG. 2 is a circuit for controlling beverage supply 9, and is configured by, similar or identical to controller 6, a microcomputer such as a CPU. Controller 6 and supply controller 8 may be formed in a single semiconductor element.

Next, screens to be shown on touch panel 5, i.e. the display unit of display device 100, will now be described herein with reference to FIGS. 3 to 8.

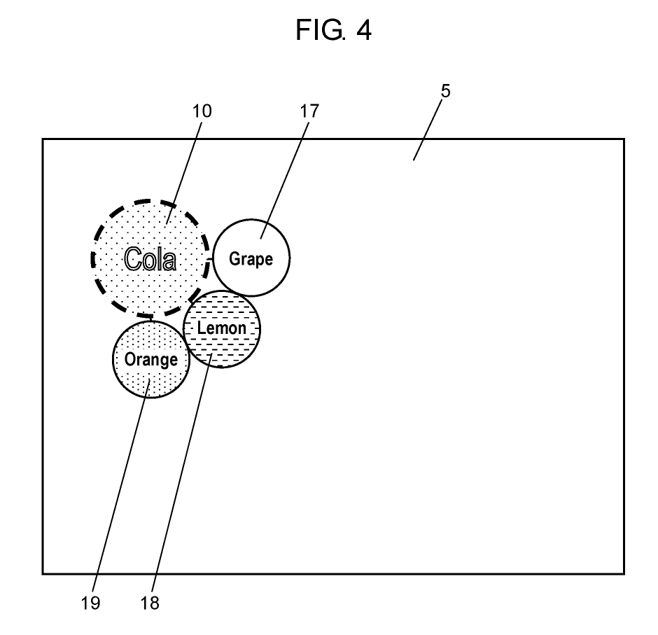

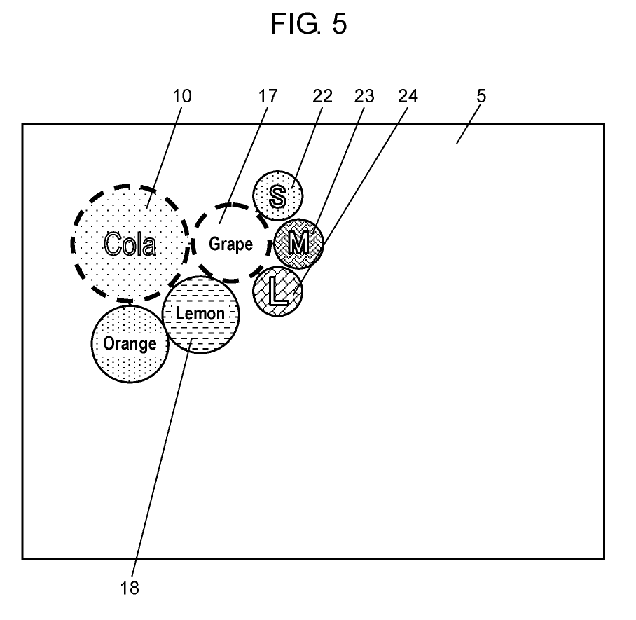

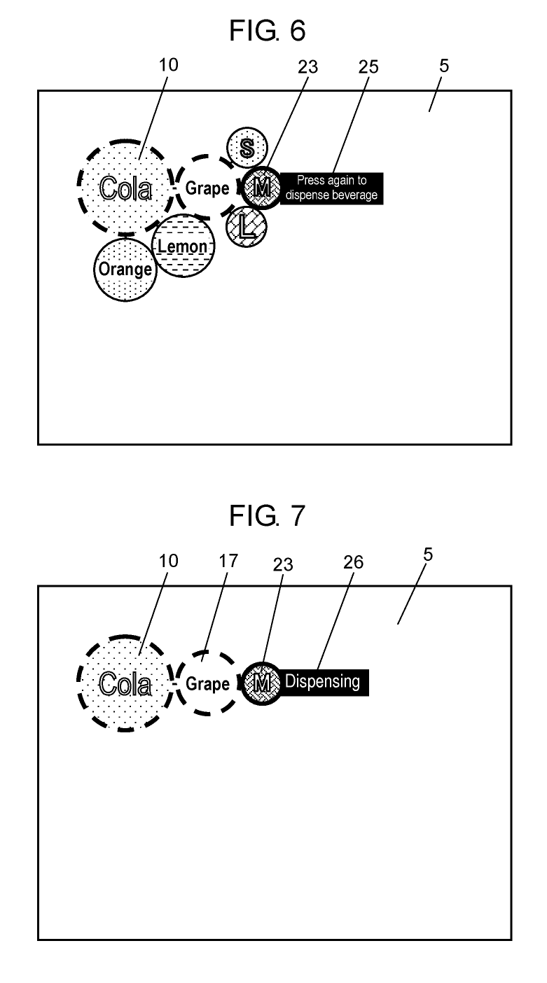

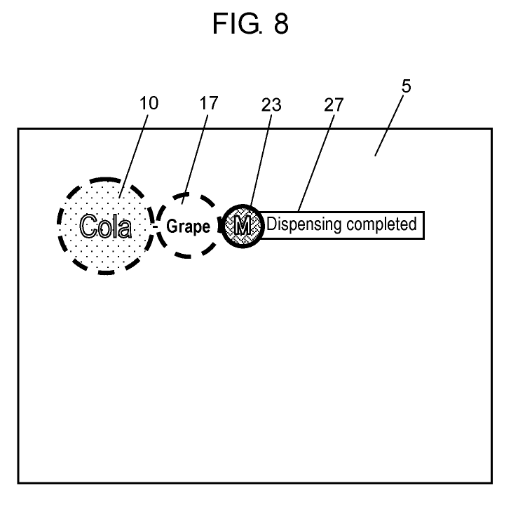

FIG. 3 is a view illustrating icons on the first hierarchy shown on display device 100 according to the first exemplary embodiment of the present disclosure. FIG. 4 is a view illustrating icons on the second hierarchy shown on display device 100 according to the first exemplary embodiment of the present disclosure. FIG. 5 is a view illustrating icons on the third hierarchy shown on display device 100 according to the first exemplary embodiment of the present disclosure. FIG. 6 is a view illustrating a beverage ready-to-dispense screen shown on display device 100 according to the first exemplary embodiment of the present disclosure. FIG. 7 is a view illustrating a beverage dispensing screen shown on display device 100 according to the first exemplary embodiment of the present disclosure. FIG. 8 is a view illustrating a beverage dispensing completion screen shown on display device 100 according to the first exemplary embodiment of the present disclosure.

Display device 100 according to this exemplary embodiment initially shows, on touch panel 5, as an initial screen, images respectively corresponding to the plurality of items on the first hierarchy (hereinafter sometimes simply referred to as images corresponding to the plurality of items). Specifically, as shown in FIG. 3, images respectively corresponding to the plurality of items of the base beverage menu on the first hierarchy are shown in icons, i.e. cola icon 10, cider icon 11, tea icon 12, root beer icon 13, oolong tea icon 14, and tonic water icon 15. The images are not limited to icons, but may be characters, symbols, pictures, or their combinations.

On the screen showing the images corresponding to the plurality of items on the first hierarchy, information on the plurality of items on the second hierarchy and a plurality of items on subsequent hierarchies, and other information, may further be shown. A bottom of the screen shown on touch panel 5 of display device 100, for example, may be configured to show, in characters or other forms, information on flavors that can be mixed, such as lemon and grape, i.e. the plurality of items of the flavor mix menu on the second hierarchy. According to such a configuration, a user can recognize at a glance, on the screen showing the images corresponding to the plurality of items on the first hierarchy, whether items which need to be selected on the second hierarchy or subsequent hierarchies are present, and information on items to be selected on the second hierarchy and subsequent hierarchies.

On touch panel 5 of display device 100, as shown in FIG. 3, when a user touches any of the icons (images) respectively corresponding to the plurality of items of the base beverage menu on the first hierarchy, controller 6 causes the display unit to show the icon touched by the user, in a mode indicating that the icon is selected. When a user makes an entry operation by touching cola icon 10 on touch panel 5 of display device 100, and keeping his or her finger touched on touch panel 5, for example, controller 6 determines that cola icon 10 is selected. FIG. 4 illustrates icons shown on touch panel 5 when a user keeps touching with his or her finger on cola icon 10. As shown in FIG. 4, for example, when the user makes an entry operation by keeping his or her finger touched on cola icon 10, cola icon 10 is shown in a mode indicating that the icon is being selected, i.e. a frame of cola icon 10 blinks (in FIG. 4, the blinking icon is rendered with a broken line). A reason of why the selected icon is shown, on the display unit, in a mode indicating that the icon is selected is to allow the user to visually distinguish the selected icon.

Controller 6 then causes touch panel 5 of display device 100 to show images corresponding to the plurality of items of the flavor mix menu on the second hierarchy (icons (grape icon 17, lemon icon 18, and orange icon 19)), around an image corresponding to the selected item, i.e. cola icon 10. Specifically, as shown in FIG. 4, circular grape icon 17, circular lemon icon 18, and circular orange icon 19 are shown adjacent to or touched with cola icon 10, around circular cola icon 10.

In a screen shown on touch panel 5, as shown in FIG. 4, display portions other than the image corresponding to the selected item (cola icon 10) on the first hierarchy and the images corresponding to the plurality of items (grape icon 17, lemon icon 18, and orange icon 19) on the second hierarchy may be shown darker in a color such as black or gray, or lighter in other colors. For example, portions other than the cola icon 10 selected on the first hierarchy and the plurality of items on the second hierarchy, i.e. grape icon 17, lemon icon 18, and orange icon 19, in other words, the items that are not selected on the first hierarchy, i.e. icons of cider, tea, root beer, oolong tea, and tonic water (see FIG. 3), may be shown darker in a color such as black and gray, or shown in a lighter contrast.

A reason of why the images corresponding to the item selected by the user and the images corresponding to the items that are not selected are shown on the display unit (touch panel 5) in different modes, as described above, is to allow the user to easily determine the selectable items.

According to such a configuration and a display method, in this exemplary embodiment, even if cola icon 10 on the first hierarchy and the icons corresponding to the plurality of items of the flavor mix menu on the second hierarchy are shown overlapped with the other icons that are not selected on the first hierarchy, the user is still able to easily determine the selectable items.

Display device 100 according to this exemplary embodiment causes a frame of the selected icon, i.e. the item selected by the user, to blink, as a mode indicating that the icon (item) is selected. However, a mode for indicating that an icon (item) is selected is not limited to the above described mode. For example, a size, a color, or another feature of a selected icon may be changed to highlight the selected icon.

When the user successively makes an entry operation by tracing his or her finger being touched on cola icon 10 shown on touch panel 5 (input unit) of display device 100 toward grape icon 17, controller 6 causes touch panel 5 to show, in icons, as shown in FIG. 5, images respectively corresponding to the plurality of items of cup sizes on the third hierarchy. Display device 100 according to this exemplary embodiment shows circular size S icon 22, circular size M icon 23, and circular size L icon 24, adjacent to or touched with grape icon 17, for example, around grape icon 17. A frame of grape icon 17 is also shown at this time on touch panel 5, in a mode indicating that the icon is selected, i.e. the frame blinks.

When a user selects one of the images corresponding to the plurality of items on the second hierarchy on display device 100 through an entry operation, as shown in FIG. 5, by tracing his or her finger being kept touched on touch panel 5 toward the desired image, an icon determined by controller 6 as selected is shown on touch panel 5, in a mode indicating that the icon is selected. A selection of the icon is not however determined yet at this point, but the icon can be selected after the user further makes an entry operation by tracing again the image on touch panel 5.

For example, after the user traces his or her finger from cola icon 10 toward grape icon 17 on touch panel 5 of display device 100, and then, without releasing the finger from touch panel 5, the user successively moves the finger toward lemon icon 18, controller 6 determines that lemon icon 18 is selected. Controller 6 causes a frame of lemon icon 18 to blink at this time, i.e. the icon is shown in a mode indicating that the icon is selected. On the other hand, the frame of grape icon 17 does not blink.

With an entry operation on the third hierarchy, similar or identical to the entry operation on the second hierarchy, any image can be selected from the images (icons) respectively corresponding to the plurality of items. That is, after the user makes an entry operation by successively tracing his or her finger being touched on grape icon 17 that is one of the images corresponding to the plurality of items on the second hierarchy, on touch panel 5 of display device 100 toward any of the images (icons) corresponding to the plurality of items on the third hierarchy, for example, size M icon 23, controller 6 determines that size M icon 23 is selected. FIG. 6 illustrates a display screen shown on touch panel 5 of display device 100 when the user has moved his or her finger toward size M icon 23 on the third hierarchy.

Display device 100 according to this exemplary embodiment does not include a plurality of items on a fourth hierarchy to be shown successively to the third hierarchy. In such a case, when the user makes an entry operation by touching size M icon 23 on the cup size menu on the third hierarchy, once releasing his or her finger from touch panel 5 of display device 100, and touching again size M icon 23, as shown in FIG. 6, controller 6 causes touch panel 5 to show beverage dispensing method message 25 (for example, “Press again to dispense beverage”). When the user makes an entry operation by touching beverage dispensing method message 25 on touch panel 5 (the input unit), controller 6 causes, based on the entry operation on the input unit, beverage supply 9 of beverage dispenser 1 to dispense a beverage. After the user has released his or her finger from size M icon 23, the screen as shown in FIG. 6 is kept unchanged. When the user makes an entry operation at this time on the input unit in order to return to the initial screen, the display unit of display device 100 shows the initial screen set beforehand. In this exemplary embodiment, when a portion of touch panel 5 of display device 100, where no icon is shown, is touched, touch panel 5 shows, as shown in FIG. 3, the screen (the initial screen) with the images corresponding to the plurality of items on the first hierarchy.

Before beverage dispenser 1 dispenses a beverage, by touching one of the images (icons) corresponding to the plurality of items on at least either of the second and third hierarchies, the user can select different one of the icons corresponding to the plurality of items on at least either of the second and third hierarchies, other than the already selected icon.

With display device 100 according to this exemplary embodiment, when the user makes an entry operation, on touch panel 5, by once releasing his or her finger from the icon (size M icon 23, for example) already selected on the third hierarchy, and then touching the same icon (size M icon 23) again, touch panel 5 shows beverage dispensing method message 25. When the user makes an entry operation by following beverage dispensing method message 25 to touch the same icon (size M icon 23) again, beverage dispenser 1 dispenses a beverage. A method used in display device 100 for dispensing a beverage is not limited to the above described method. Another method, for example, where buttons or other devices will be shown on completely different locations on touch panel 5 of display device 100 for dispensing a beverage may be adopted. Still another method where a hard button is provided separately, from touch panel 5, on display device 100 to dispense a beverage when a user presses this hard button may otherwise be adopted.

FIG. 7 shows an appearance of touch panel 5 of display device 100, when beverage dispenser 1 is dispensing a beverage, after the user has made an entry operation by following beverage dispensing method message 25 to touch again size M icon 23.

When controller 6 controls beverage supply 9 of beverage dispenser 1, and beverage dispenser 1 begins dispensing of a beverage, as shown in FIG. 7, controller 6 switches beverage dispensing method message 25 shown on touch panel 5 of display device 100 to dispensing message 26. Touch panel 5 of display device 100 shows only three icons (images), i.e. cola icon 10, grape icon 17, and size M icon 23. Since these three icons have already been selected and determined by the user, frames of all the icons are blinking.

FIG. 8 illustrates a state where, after beverage dispenser 1 has completed dispensing of the beverage, touch panel 5 of display device 100 shows dispensing completion message 27.

After controller 6 has caused the display unit (touch panel 5, in this exemplary embodiment) of display device 100 to show dispensing completion message 27, as shown in FIG. 8, controller 6 causes the display unit to automatically show the initial screen set beforehand when a predetermined period has passed (after several seconds, for example). In display device 100 according to this exemplary embodiment, controller 6 causes the display unit, i.e. touch panel 5, to automatically show, as shown in FIG. 3, the initial screen with the images corresponding to the plurality of items on the first hierarchy when a predetermined period has passed (after several seconds, for example).

Storage unit 7 stores various messages to be shown on touch panel 5, such as beverage dispensing method message 25, dispensing message 26, and dispensing completion message 27.

Display device 100 according to this exemplary embodiment is configured such that, after beverage dispenser 1 has dispensed a beverage, controller 6 causes touch panel 5 of display device 100 to show the screen (initial screen) again with the images corresponding to the plurality of items on the first hierarchy. However, operations of display device 100 after a beverage has been dispensed are not limited to the above described operations. For example, depending on a setting, an image corresponding to a selected item for a dispensed beverage may be kept shown on touch panel 5 of display device 100, in a mode indicating that the image is selected (that is, display on touch panel 5 does not automatically return to the initial screen). Otherwise, when a user touches another display area on touch panel 5, controller 6 may cause touch panel 5 to show again the initial screen set beforehand.

As described above, when a user makes a predetermined entry operation on the input unit (touch panel 5, in this exemplary embodiment) of display device 100, for example, an entry operation, as described above, by tracing his or her finger being kept touched on an image (icon) on the input unit toward another image, the user can easily and promptly select items on a plurality of menus. A time can therefore be reduced for making entry operations for selecting desired items from a plurality of items on a plurality of hierarchies, and combining the selected items to obtain a desired combination.

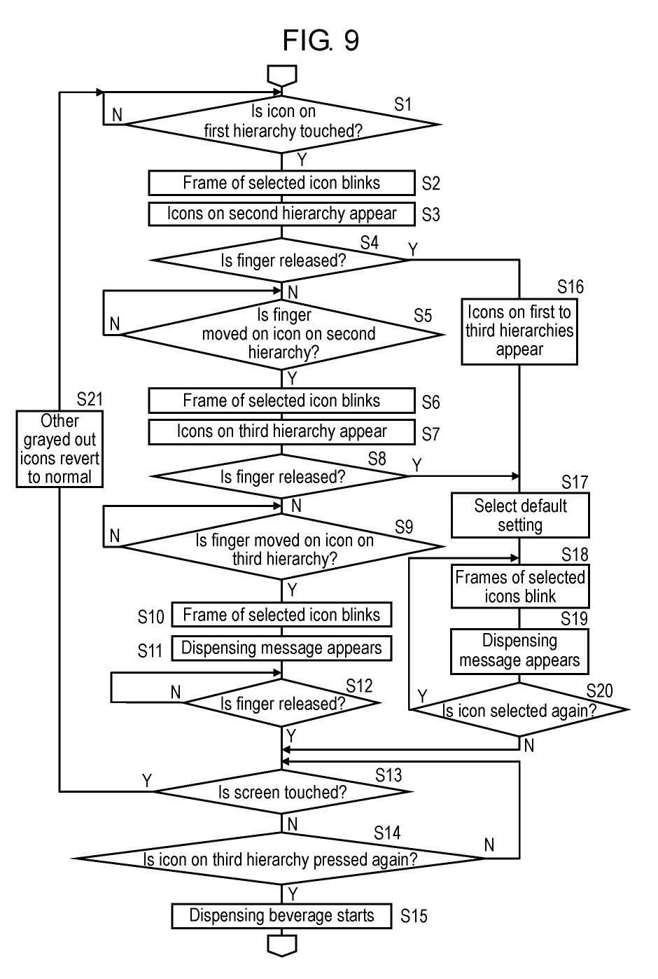

Next, operations of beverage dispenser 1 equipped with display device 100 according to the first exemplary embodiment will now be described herein with reference to the flowchart shown in FIG. 9.

FIG. 9 is the flowchart illustrating operations of beverage dispenser 1 equipped with display device 100 according to one of the first to seventh exemplary embodiments of the present disclosure.

In Step S1, controller 6 causes the display unit (touch panel 5, in this exemplary embodiment) of display device 100 to show, as shown in FIG. 3, the images respectively corresponding to the plurality of items on the first hierarchy, i.e. the plurality of icons (cola icon 10, cider icon 11, tea icon 12, root beer icon 13, oolong tea icon 14, and tonic water icon 15). Controller 6 then determines whether a user has made, on the input unit (touch panel 5, in this exemplary embodiment) of display device 100, an entry operation by touching any of the plurality of icons on the first hierarchy. When controller 6 determines that the user has touched any of the plurality of icons on the first hierarchy, a process proceeds to Step S2.

In Step S2, controller 6 causes the display unit to show the icon touched (selected) by the user on the first hierarchy, in a mode indicating that the icon is selected. In this exemplary embodiment, for example, controller 6 causes the display unit (touch panel 5) to blink, as described above, a frame of the icon determined as selected on the first hierarchy, based on the entry operation made by the user on the input unit (touch panel 5).

In Step S3, controller 6 then causes touch panel 5 of display device 100 to show the images corresponding to the plurality of items on the second hierarchy, i.e. the plurality of icons (grape icon 17, lemon icon 18, and orange icon 19). Controller 6 causes, at this time, touch panel 5 to show, as shown in FIG. 4, the icon selected by the user on the first hierarchy, and the images corresponding to the plurality of items on the second hierarchy, i.e., the plurality of icons.

In Step S4, when controller 6 determines that the user keeps touching his or her finger on touch panel 5, the process proceeds to Step S5. When controller 6 determines that the user has released his or her finger from touch panel 5, the process proceeds to Step S16.

In Step S5, when controller 6 determines that the user has subsequently moved his or her finger being kept touched on touch panel 5 toward any of the icons on the second hierarchy, the process proceeds to Step S6. In this exemplary embodiment, controller 6 simultaneously executes Steps S6 and S7 described below.

In Step S6, controller 6 causes the display unit (touch panel 5) to blink a frame of the icon determined as selected on the second hierarchy, based on the entry operation made by the user on the input unit (touch panel 5).

In Step S7, controller 6 causes the display unit (touch panel 5) to show the images corresponding to the plurality of items on the third hierarchy, i.e., the plurality of icons (size S icon 22, size M icon 23, and size L icon 24). Controller 6 causes at this time the display unit (touch panel 5) to show, as shown in FIG. 5, the plurality of icons on the third hierarchy, around the icon (image) selected on the second hierarchy, for example, adjacent to or touched with the icon selected on the second hierarchy.

In Step S8, when controller 6 determines that the user has made an entry operation on the input unit (touch panel 5) by keeping his or her finger touched on touch panel 5, the process proceeds to Step S9. When controller 6 determines that the user has released his or her finger from touch panel 5, the process proceeds to Step S17.

In Step S9, when controller 6 determines that the user has made an entry operation on the input unit (touch panel 5) by moving his or her finger being touched on touch panel 5 toward any of the icons on the third hierarchy without releasing the finger from touch panel 5, the process proceeds to Step S10. In this exemplary embodiment, controller 6 simultaneously executes Steps S10 and S11 described below.

In Step S10, controller 6 causes touch panel 5 to blink a frame of the icon determined as selected on the third hierarchy through the entry operation in Step S9.

In Step S11, controller 6 causes touch panel 5 to show beverage dispensing method message 25 adjacent to the icon determined as selected on the third hierarchy through the entry operation in Step S9. Controller 6 at this time causes touch panel 5 to show, as shown in FIG. 6, beverage dispensing method message 25, for example, a message “Press again to dispense beverage,” around the icon selected on the third hierarchy, for example, adjacent to or touched with the icon selected on the third hierarchy.

In Step S12, when controller 6 determines that the user has made an entry operation on the input unit (touch panel 5) by releasing his or her finger from touch panel 5, the process proceeds to Step S13.

In Step S13, when controller 6 determines that the user has made an entry operation on the input unit (touch panel 5) by touching with his or her finger on an area where no icon is shown on touch panel 5, the process proceeds to Step S21. If such a touch operation is not determined, the process proceeds to Step S14.

In Step S14, when controller 6 determines that the user has made an entry operation on the input unit (touch panel 5) by touching again (pressing again) with his or her finger on the icon selected by the user on the third hierarchy, the process proceeds to Step S15. If such a touch operation is not determined, the process returns to Step S13.

In Step S15, controller 6 causes the display unit (touch panel 5) to show dispensing message 26 adjacent to the icon selected on the third hierarchy. Controller 6 simultaneously controls supply controller 8 of beverage dispenser 1, and drives beverage supply 9 to cause beverage dispenser 1 to dispense a beverage. Controller 6 at this time causes touch panel 5 to show, as shown in FIG. 7, dispensing message 26, i.e. a message “Dispensing” adjacent to the icon selected on the third hierarchy. When controller 6 determines that beverage dispenser 1 has completed dispensing of the beverage, as shown in FIG. 3, controller 6 causes touch panel 5 to show the screen (initial screen) with the plurality of items on the first hierarchy, and the process returns to Step S1.

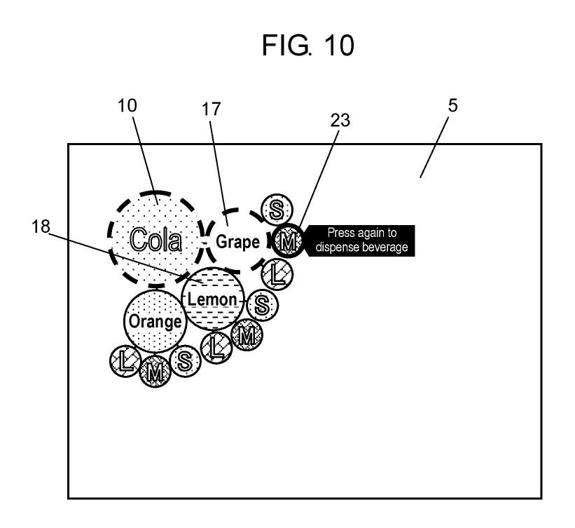

In Step S16, controller 6 causes touch panel 5 to show, as shown in FIG. 10, the selected icon (cola icon 10) on the first hierarchy, in a mode indicating that the icon is selected (for example, the frame of the icon blink), and to show the plurality of icons on the second and third hierarchies, and the process proceeds to Step S17.

In Step S17, controller 6 automatically selects default icons that are associated with the icon selected on the first hierarchy, and that are set in storage unit 7 beforehand.

In this exemplary embodiment, controller 6 executes Steps S18, S19, and S20 described below.

In Step S18, controller 6 causes touch panel 5 to blink frames of the default icons selected in Step S17.

In Step S19, controller 6 causes touch panel 5 to show beverage dispensing method message 25 adjacent to the default icon selected on the third hierarchy.

Steps S17 and S18 will now be specifically described herein. In the process from Step S16, controller 6 causes touch panel 5 to show, as shown in FIG. 10, the respective plurality of icons on the second and third hierarchies, while to blink only the icon selected on the first hierarchy. Controller 6 simultaneously selects, from the respective plurality of icons on the second and third hierarchies, default icons (default settings) that are associated with the icon (image) selected on the first hierarchy, are set beforehand, and are stored in storage unit 7 (Step S17). Controller 6 then causes touch panel 5 to blink these default icons (grape icon 17 and size M icon 23, in this exemplary embodiment) (Step S18).

On the other hand, in the process from Step S8, controller 6 causes touch panel 5 to show the icon selected on the first hierarchy, and the respective plurality of icons on the second and third hierarchies, where only the icons selected on the first and second hierarchies blink. Controller 6 simultaneously selects, from the plurality of icons on the third hierarchy, the default icon (default setting) associated with the icon selected on the first hierarchy and the default icon on the second hierarchy, set beforehand, and stored in storage unit 7 (Step S17). Controller 6 then causes touch panel 5 to blink the default icon on the third hierarchy (size M icon 23, in this exemplary embodiment) (Step S18).

Next, in Step S20, when controller 6 determines that the user has made (selected) an entry operation by touching again with his or her finger on the icons on the respective hierarchies (Yes in Step S20), the process returns to Step S18. If controller 6 determines that the icons are not touched again (not selected) (No in Step S20), the process proceeds to Step S13.

That is, with display device 100 and a display method for display device 100, according to this exemplary embodiment, in selecting images (icons) corresponding to a plurality of items on each hierarchy, even if a user has ceased an entry operation of tracing icons shown on touch panel 5 of display device 100 (even if the user has released his or her finger from touch panel 5), the user is still able to select the images again. According to such a configuration and a display method, even if a user has failed to make a selection, the user is still able to promptly and easily select again the images corresponding to the desired items.

In Step S21, controller 6 causes touch panel 5 to cancel the darkish area (gray out) shown in the above described screen, as shown in FIG. 6, but to show the screen (initial screen) with the plurality of icons on the first hierarchy, as shown in FIG. 3, and the process returns to Step S1.

Steps S16 to S20 shown in FIG. 9 also relate to a second exemplary embodiment described later.

With display device 100 and the display method for display device 100, according to this exemplary embodiment, as described above, even if a user has failed to select an icon in each hierarchy, the user can still promptly return, with an easy operation, to the initial screen (the screen shown with the images (icons) corresponding to the plurality of items on the first hierarchy, as shown in FIG. 3).

In this exemplary embodiment, exemplary display device 100 and the exemplary display method for display device 100, have been described using a device for dispensing a beverage (beverage dispenser 1). However, such a display device and a display method for the display device are not limited to the above description. That is, such a machine including a display device from which a plurality of items can be selected from menus on at least two hierarchies is not limited to a beverage dispenser, but applicable to other electronic devices such as ticket vending machines, concert ticket vending machines, televisions, and Blu-ray (registered trademark) recorders.

### Second Exemplary Embodiment

Next, display device 100 and a display method for display device 100, according to a second exemplary embodiment of the present disclosure will now be described herein. In the second exemplary embodiment, an appearance and a block diagram illustrating an internal configuration of beverage dispenser 1 are identical to the appearance and the block diagram of the internal configuration of beverage dispenser 1 according to the first exemplary embodiment, thus their descriptions are omitted.

Display device 100 and the display method for display device 100, according to the second exemplary embodiment of the present disclosure, are configured such that, when a user makes an entry operation on touch panel 5, i.e., an input unit of display device 100, by touching with his or her finger on any of the plurality of items on the first hierarchy, and then releasing the finger, the images that correspond to the respective items on the second and third hierarchies, that are associated with the item determined by the controller as selected on the first hierarchy, and that are set beforehand (by default), are selected.

FIG. 10 is a view illustrating a display screen shown on a touch panel of display device 100 according to the second exemplary embodiment of the present disclosure. FIG. 10 illustrates a screen to be shown on the display unit (touch panel 5) of display device 100, when controller 6 determines that a user has made an entry operation on the input unit (touch panel 5) of display device 100 by touching with his or her finger on cola icon 10 on the first hierarchy, and then releasing the finger from touch panel 5 without selecting other icons. In this case, controller 6 causes touch panel 5 to show the image (cola icon 10) selected on the first hierarchy, and the plurality of images corresponding to the respective plurality of items on the second and third hierarchies. The images to be selected respectively at this time on the second and third hierarchies are the images (grape icon 17 and size M icon 23, for example) that are associated with the items corresponding to the image selected on the first hierarchy, that are set beforehand, that are stored in storage unit 7, and that correspond to predetermined items (for example, grape and size M cup) to be selected by controller 6. The predetermined items will automatically be selected by controller 6, when controller 6 determines that the user has made an entry operation on touch panel 5 (the input unit) of display device 100 by touching with his or her finger on any of the images corresponding to the plurality of items on the first hierarchy, and then releasing the finger from touch panel 5 without selecting other icons. Controller 6 then causes touch panel 5 (the display unit) to show the images corresponding to the predetermined items selected automatically. The images corresponding to the predetermined items are also set beforehand and stored in storage unit 7.

Controller 6 causes touch panel 5 to show the images corresponding to the respective predetermined items automatically selected by controller 6 on the second and third hierarchies, in a mode indicating that the images are selected, for example, frames of the icons blink.

In this exemplary embodiment, controller 6 automatically selects the predetermined items that are associated with a cola item corresponding to cola icon 10 selected by the user on the first hierarchy, are set beforehand, and are stored in storage unit 7, i.e., a default grape item on the second hierarchy, and a default size M item on the third hierarchy. Controller 6 then causes touch panel 5 (the display unit) to show an image of grape icon 17 corresponding to the default grape item on the second hierarchy, and an image of size M icon 23 corresponding to the default size M item on the third hierarchy.

Controller 6 then causes touch panel 5 to show, as shown in FIG. 10, in addition to cola icon 10 selected by the user on the first hierarchy, default grape icon 17 and default size M icon 23 automatically selected by controller 6, in a mode indicating that the icons are selected, i.e., frames of the icons blink.

The items of cola, grape, and size M cup, and the images respectively corresponding to the items, i.e. cola icon 10, grape icon 17, and size M icon 23, in the above described example, are default settings associated each other and set beforehand by an operator when the display device is shipped from factory or by a user, and are stored in storage unit 7. Terms “associated each other” and “set beforehand” used herein mean that, for example, when controller 6 determines that cola icon 10 is selected through a predetermined entry operation on touch panel 5 (the input unit) of display device 100, the grape item and the size M cup item are associated with the cola item corresponding to selected cola icon 10 (image), and set beforehand so as to automatically be selected by controller 6.

For this default setting, a user may change the items and images set beforehand. The default setting may be changed in such a manner that, for example, when controller 6 determines that a user has selected any of the images corresponding to the plurality of items on the second hierarchy, instead of the first hierarchy, controller 6 selects a default setting set in the third hierarchy so as to be associated with an item corresponding to the image selected by the user on the second hierarchy. For example, when controller 6 determines that a user has selected lemon icon 18 on the second hierarchy, controller 6 automatically selects the default set image of size M icon 23 on the third hierarchy associated with an image of lemon icon 18 on the second hierarchy and stored in storage unit 7.

As described above, in display device 100 according to this exemplary embodiment, items that are associated with an image corresponding to one of the items on the first hierarchy, and that are to be selected respectively on the second and third hierarchies lower than the first hierarchy, and images corresponding to the items are set beforehand as a default setting, and stored in storage unit 7. As described above, when controller 6 determines that, for example, a user has made an entry operation on touch panel 5 (the input unit) of display device 100 by selecting, with his or her finger, cola icon 10 on touch panel 5, and then releasing the finger, controller 6 automatically selects predetermined items that are associated with the item corresponding to the image of cola icon 10 on the first hierarchy, are set beforehand by default, and are stored in storage unit 7, i.e., the grape item on the second hierarchy, and the size M cup item on the third hierarchy. Controller 6 then causes touch panel 5 (the display unit) to show the image of grape icon 17 corresponding to the grape item on the second hierarchy, and the image of size M icon 23 corresponding to the size M cup item on the third hierarchy.

With display device 100 according to this exemplary embodiment, the item on the third hierarchy that is associated with the item corresponding to the image selected on the second hierarchy and that is lower than the second hierarchy is set beforehand as a default setting, and is stored in storage unit 7. For example, when a user makes an entry operation on touch panel 5 by selecting, with his or her finger, cola icon 10 on the first hierarchy, and then successively selecting grape icon 17 on the second hierarchy without releasing the finger from touch panel 5, controller 6 automatically selects, on the third hierarchy, based on the entry operation on touch panel 5, the size M cup item that is associated with the cola item corresponding to the image of cola icon 10 on the first hierarchy and the grape item corresponding to grape icon 17 on the second hierarchy, is set beforehand, and is stored in storage unit 7. Controller 6 then causes touch panel 5 (the display unit) to show the image of size M icon 23 corresponding to the size M cup item on the third hierarchy. That is, as a default setting for when cola icon 10 is selected on the first hierarchy, and then grape icon 17 is selected on the second hierarchy, size M icon 23 is set beforehand so as to automatically be selected by controller 6.

As described above, with display device 100 and the display method for display device 100, according to this exemplary embodiment, items on hierarchies lower than another hierarchy including an image selected by a user are set beforehand by default, and stored in storage unit 7 so as to automatically be selected by controller 6. Controller 6 then causes touch panel 5 (the display unit) to show images corresponding to the predetermined items to automatically be selected. According to such a configuration and a display method, a user can select a beverage with a less number of touch operations, thus a time and effort required for entry operations can be reduced.

In display device 100 and the display method for display device 100, according to this exemplary embodiment, display device 100 may be configured such that, when a user makes an entry operation on touch panel 5, as shown in FIG. 10, by touching, with his or her finger, cola icon 10 on the first hierarchy, and then releasing the finger from touch panel 5 without selecting any icon on the second hierarchy, but selecting any of the images corresponding to the plurality of items on the third hierarchy, controller 6 automatically selects an image that is associated with the image selected on the third hierarchy, and that corresponds to one of the items on the second hierarchy set beforehand by default.

Specifically, when the user makes an entry operation on touch panel 5 by touching size M icon 23 shown adjacent to grape icon 17 after the user has released his or her finger from cola icon 10, controller 6 automatically selects grape icon 17. That is, with display device 100 and the display method for display device 100, according to this exemplary embodiment, a user can automatically select all of cola icon 10, grape icon 17, and size M icon 23 by selecting only two icons, i.e., cola icon 10, and size M icon 23 shown adjacent to grape icon 17, without selecting in order each of cola icon 10, grape icon 17, and size M icon 23. In other words, with display device 100 and the display method for display device 100, according to this exemplary embodiment, when a user selects images respectively corresponding to any of the items on the first hierarchy, and any of the plurality of items on the third hierarchy, an image corresponding to one of the items on the second hierarchy is automatically selected. In this case, for example, since only grape icon 17 is present between cola icon 10 and size M icon 23, the user is not required to set one of the items in the second hierarchy beforehand.

According to such a configuration and a display method, a user can select a beverage with a less number of touch operations, thus a time and effort required for entry operations can be reduced.

### Third Exemplary Embodiment

Next, display device 100 and a display method for display device 100, according to a third exemplary embodiment of the present disclosure will now be described herein. In the third exemplary embodiment, an appearance and a block diagram illustrating an internal configuration of beverage dispenser 1 are identical to the appearance and the block diagram of the internal configuration of beverage dispenser 1 according to the first exemplary embodiment, thus their descriptions are omitted.

With display device 100 and the display method for display device 100, according to the third exemplary embodiment of the present disclosure, a user can change types and the number of items required for dispensing a beverage.

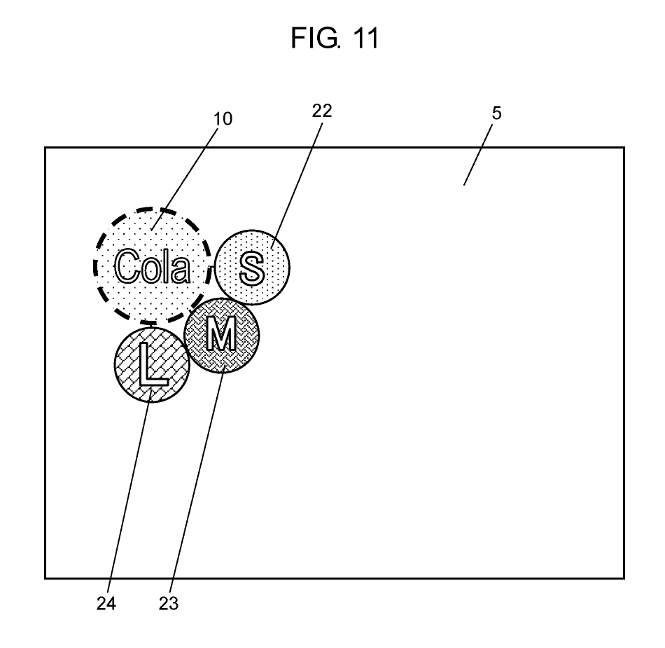

FIG. 11 is a view illustrating a display screen shown on a touch panel of display device 100 according to the third exemplary embodiment of the present disclosure. More specifically, FIG. 11 illustrates an exemplary display screen shown on touch panel 5 of display device 100 when a user has changed types and the number of items required for dispensing a beverage.

With touch panel 5 of display device 100 according to the third exemplary embodiment of the present disclosure, for example, a user can make selections on the base beverage menu on the first hierarchy and the cup size menu on the third hierarchy only without making a selection on the flavor mix menu on the second hierarchy. In this case, when a user selects cola icon 10 on the screen shown, on touch panel 5, with the images corresponding to the plurality of items on the first hierarchy, as shown in FIG. 3, controller 6 determines that the user has made an entry operation on touch panel 5 by selecting cola icon 10. Controller 6 then causes touch panel 5 to show, as shown in FIG. 11, the images of the plurality of cup size icons (size S icon 22, size M icon 23, and size L icon 24) corresponding to the plurality of items on the third hierarchy, around cola icon 10 selected on the first hierarchy, without showing the images corresponding to the plurality of items of the flavor mix menu on the second hierarchy.

As described above, display device 100 and the display method for display device 100, according to this exemplary embodiment, can be set such that, for example, if a user does not always add a flavor mix into a beverage, i.e., making a selection from the flavor mix menu on the second hierarchy is not required, touch panel 5 does not show, based on a predetermined entry operation made by the user on the touch panel 5, the images (icons) corresponding to the plurality of items for making a selection from the flavor mix menu on the second hierarchy. In this exemplary embodiment, restaurants and other similar service providers providing beverages are supposed to make such settings depending on users' needs. However, a user may make such settings.

With display device 100 and the display method for display device 100, according to this exemplary embodiment, even when a user causes beverage dispenser 1 to dispense a beverage without adding any of the flavor mix menu on the second hierarchy, the user can select, in a single touch operation (entry operation) on touch panel 5, the beverage without making any selection from the flavor mix menu on the second hierarchy. Specifically, when a user intends to make two selections: any of the base beverage menu on the first hierarchy and a cup size on the third hierarchy, the user can select a beverage, without making any selection from the flavor mix menu on the second hierarchy, in a single touch operation (entry operation) on touch panel 5 of tapping with his or her finger a desired base beverage menu (cola icon 10, for example), and of successively tracing the finger toward a desired cup size (size M icon 23, for example).

According to such a configuration and a display method, a time and effort can be reduced for making entry operations for selecting desired items from a plurality of items on a plurality of hierarchies.

In display device 100 and the display method for display device 100, according to this exemplary embodiment, a configuration where touch panel 5 does not show the plurality of items on the second hierarchy has been exemplified. However, a hierarchy that will not be shown on touch panel 5 may be the third hierarchy or the fourth hierarchy. Otherwise a configuration where a plurality of hierarchies, such as the third and fourth hierarchies, is not shown may be adopted.

### Fourth Exemplary Embodiment

Next, display device 100 and a display method for display device 100, according to a fourth exemplary embodiment of the present disclosure will now be described herein. In the fourth exemplary embodiment, an appearance and a block diagram illustrating an internal configuration of beverage dispenser 1 are identical to the appearance and the block diagram of the internal configuration of beverage dispenser 1 according to the first exemplary embodiment, thus their descriptions are omitted.

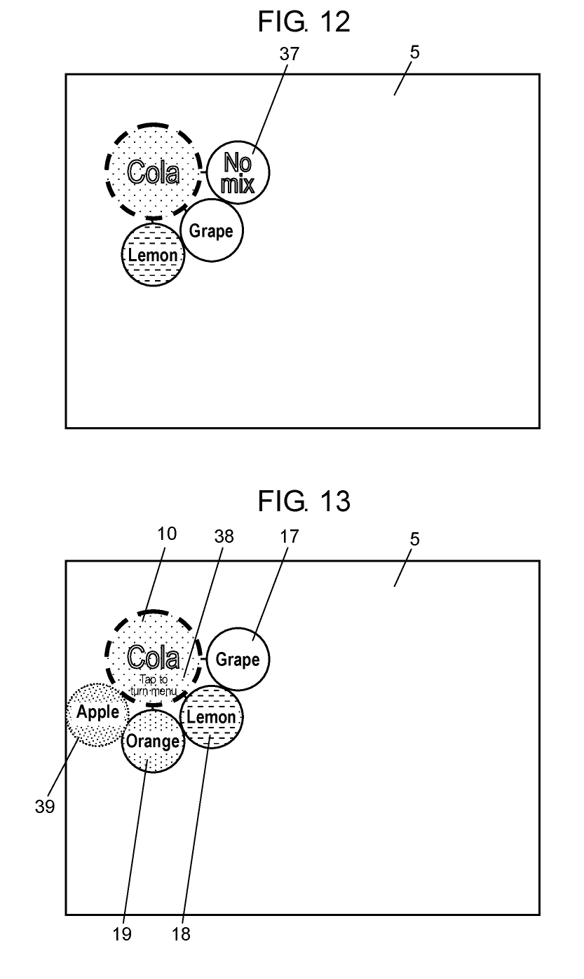

FIG. 12 is a view illustrating a display screen shown on a touch panel of display device 100 according to the fourth exemplary embodiment of the present disclosure.

In display device 100 according to the fourth exemplary embodiment of the present disclosure, as shown in FIG. 12, no mix icon 37 is included in the plurality of images corresponding to the plurality of items on the second hierarchy.

With display device 100 according to the fourth exemplary embodiment of the present disclosure, a user can cause beverage dispenser 1 to dispense a base beverage selected from the base beverage menu on the first hierarchy by selecting no mix icon 37 from the images corresponding to the plurality of items on the second hierarchy shown on touch panel 5. According to such a configuration, a single beverage (a beverage selected from a single menu) can be selected. When controller 6 determines that no mix icon 37 is selected on the second hierarchy shown on touch panel 5 of display device 100, controller 6 controls supply controller 8 and beverage supply 9 of beverage dispenser 1 to cause beverage dispenser 1 to dispense a beverage selected with an item corresponding to an image selected on the first hierarchy. Controller 6 may be configured to cause touch panel 5 to show, when controller 6 determines that no mix icon 37 is selected on touch panel 5 of display device 100, the images of the plurality of cup size icons corresponding to the plurality of items on the third hierarchy, around no mix icon 37 on the second hierarchy.

### Fifth Exemplary Embodiment

Next, display device 100 and a display method for display device 100, according to a fifth exemplary embodiment of the present disclosure will now be described herein. In the fifth exemplary embodiment, an appearance and a block diagram illustrating an internal configuration of beverage dispenser 1 are identical to the appearance and the block diagram of the internal configuration of beverage dispenser 1 according to the first exemplary embodiment, thus their descriptions are omitted.

Display device 100 and the display method for display device 100, according to the fifth exemplary embodiment of the present disclosure, is configured such that a plurality of images corresponding to a plurality of items on a hierarchy is separated into a plurality of pages and stored in storage unit 7, and the display unit switches and shows each of the plurality of pages in order. This exemplary embodiment is effective when, for example, touch panel 5 cannot show at once, due to its limited display area, all images of a plurality of items on the second hierarchy. This exemplary embodiment will now specifically be described herein.

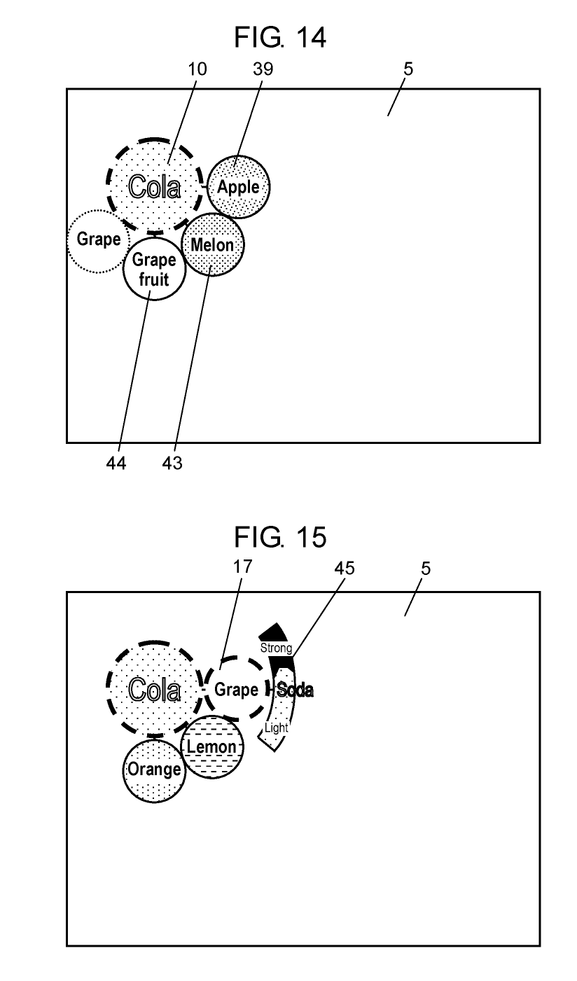

FIG. 13 is a view illustrating a display screen shown on touch panel 5 of display device 100 according to the fifth exemplary embodiment of the present disclosure. FIG. 14 is a view illustrating another display screen shown on touch panel 5 of display device 100 according to the fifth exemplary embodiment of the present disclosure.

Display device 100 according to this exemplary embodiment includes, as a plurality of images corresponding to a plurality of items on the second hierarchy, items of apple icon 39, orange icon 19, lemon icon 18, grape icon 17, grapefruit icon 44, and melon icon 43.

When controller 6 determines that a user has selected cola icon 10 on the first hierarchy shown on touch panel 5, controller 6 causes touch panel 5 to show an appearance indicating that a page showing the images corresponding to the plurality of items on the second hierarchy can be switched. Specifically, controller 6 causes cola icon 10 selected on the first hierarchy to show, as shown in FIG. 13, page switch message 38 (“Tap to turn menu,” for example). Controller 6 simultaneously causes touch panel 5 to show the icons on the second hierarchy, in a mode suggesting that another page is available on the second hierarchy (the icons are shown translucent, for example). In FIG. 13, frames of the icons are rendered with a fine dotted line to show that the frames of the icons are translucent.

Controller 6 causes touch panel 5 to show, as shown in FIG. 13, a first page from a plurality of pages including the plurality of icons on the second hierarchy. The first page of the second hierarchy shows apple icon 39, grape icon 17, lemon icon 18, and orange icon 19. In these icons, controller 6 causes touch panel 5 to show, for example, a frame of apple icon 39 translucent. In this state, when controller 6 determines that a user has followed page switch message 38 and made an entry operation by touching again the selected icon (cola icon 10 in FIG. 13) on the first hierarchy, controller 6 causes touch panel 5 to switch the first page on the second hierarchy being shown to another page including items that are not yet shown on the second hierarchy. FIG. 14 shows a display state of touch panel 5 of display device 100 when a user has followed page switch message 38 and touched again cola icon 10 selected on the first hierarchy.

As shown in FIG. 14, touch panel 5 of display device 100 shows, from the plurality of pages, a second page including a plurality of images corresponding to a plurality of items of the flavor mix menu on the second hierarchy. In this exemplary embodiment, the second page on the second hierarchy shows apple icon 39, melon icon 43, grapefruit icon 44, and grape icon 17. In these icons, a frame of grape icon 17, for example, is shown translucent. In FIG. 14, the frame of the icon is rendered with a fine dotted line to show that the frame of the icon is translucent.

Showing a frame of at least one of the icons on the second hierarchy, grape icon 17 for example, translucent frame suggests that, when the user follows page switch message 38 and taps again cola icon 10 selected on the first hierarchy, the user can cause touch panel 5 to show the first page of the plurality of items on the second hierarchy, or a third page (if available) and subsequent hierarchies (subsequent pages).

As described above, with display device 100 and the display method for display device 100, according to this exemplary embodiment, even though a plurality of images corresponding to a plurality of items is set in a single hierarchy, the images are separated into a plurality of pages, and stored in storage unit 7. With display device 100 and the display method for display device 100, according to the this exemplary embodiment, a user can make an entry operation by touching a predetermined icon (cola icon 10 selected on the first hierarchy, for example) shown on touch panel 5 to easily urge controller 6 to cause touch panel 5 to switch and show a plurality of pages including a plurality of images corresponding to a plurality of items set in a single hierarchy. According to such a configuration and a display method, a user can cause touch panel 5 to easily and promptly show images corresponding to many items set in a single hierarchy.

In display device 100 and the display method for display device 100, according to this exemplary embodiment, a configuration and a display method, through which, each time a user taps cola icon 10 selected on the first hierarchy, the plurality of pages of the plurality of items on the second hierarchy switches, have been exemplified. However, the configuration and the display method are not limited to this exemplary embodiment, but the pages may be switched each time a user taps another display area or another icon shown on touch panel 5.

### Sixth Exemplary Embodiment

Next, display device 100 and a display method for display device 100, according to a sixth exemplary embodiment of the present disclosure will now be described herein. In the sixth exemplary embodiment, an appearance and a block diagram of beverage dispenser 1 are identical to the appearance and the block diagram of beverage dispenser 1 according to the first exemplary embodiment, thus their descriptions are omitted.

With display device 100 and the display method for display device 100, according to the sixth exemplary embodiment of the present disclosure, touch panel 5 of display device 100 shows setting bar 45 for soda density. Setting bar 45 is selected when a user makes an entry operation by touching or tracing setting bar 45 on touch panel 5.

With display device 100 and the display method for display device 100, according to this exemplary embodiment, as shown in FIG. 15, controller 6 causes touch panel 5 to show soda density setting bar 45 adjacent to an image corresponding to a selected item (grape icon 17, in this exemplary embodiment) on the second hierarchy.

The user can make a selection with an entry operation by touching or tracing soda density setting bar 45 shown on touch panel 5 of display device 100, in a similar or identical manner to touching or tracing an icon in the above described first to fifth exemplary embodiments. In this exemplary embodiment, setting bar 45 is configured, when shown on touch panel 5, such that an upper portion of a contrast is darker, while a lower portion of a contract is lighter, as shown in FIG. 15. The user may set desired soda density by touching setting bar 45.

For example, when controller 6 determines that a user has selected grape icon 17 from a plurality of icons shown on touch panel 5 of display device 100, controller 6 causes touch panel 5 to automatically show soda density setting bar 45 next to grape icon 17. When controller 6 determines that a user has made an entry operation by tracing, with his or her finger, setting bar 45, and then releasing the finger from setting bar 45 (the user has made a setting), controller 6 sets soda density in accordance with density set by the user.

In display device 100 and the display method for display device 100, according to this exemplary embodiment, a setting bar is used to allow a user to select a value in a continuous range. However, the present disclosure is not limited to using such a setting bar. For example, touch panel 5 may be configured to include other devices, such as a pressure sensor, a hover detector, or an installation area detector, so that a set value changes depending on how a user has pressed touch panel 5 with his or her finger.

### Seventh Exemplary Embodiment

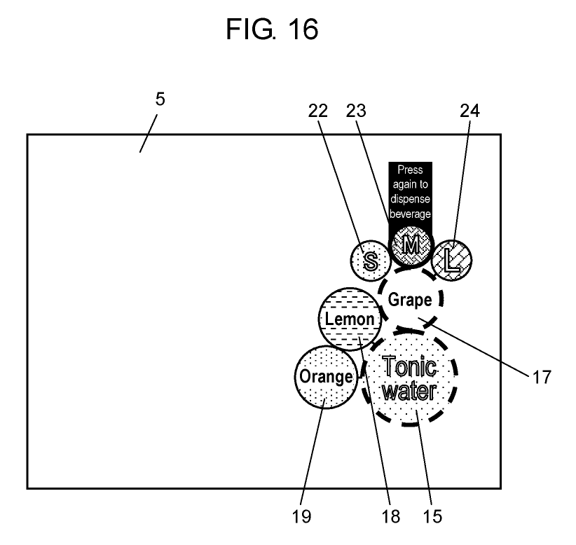

Next, display device 100 and a display method for display device 100, according to a seventh exemplary embodiment of the present disclosure, will now be described herein with reference to FIG. 16. In the seventh exemplary embodiment, an appearance and a block diagram of beverage dispenser 1 are identical to the appearance and the block diagram of beverage dispenser 1 according to the first exemplary embodiment, thus their descriptions are omitted.

With display device 100 and the display method for display device 100, according to the seventh exemplary embodiment of the present disclosure, when showing a plurality of icons, controller 6 causes touch panel 5 to show the plurality of icons on an optimum area of touch panel 5 so that the icons do not protrude from a screen of touch panel 5 of display device 100.

FIG. 16 is a view illustrating a display screen shown on a touch panel of display device 100 according to the seventh exemplary embodiment of the present disclosure. Specifically, FIG. 16 illustrates a display screen shown on touch panel 5 when a user touches and selects, with his or her finger, tonic water icon 15 on the screen (initial screen) shown with the images corresponding to the plurality of items on the first hierarchy, as shown in FIG. 3, selects grape icon 17 with the finger kept touched on touch panel 5 and traced toward grape icon 17 on the second hierarchy, and selects size M icon 23 with the finger further traced toward size M icon 23 on the third hierarchy.

As shown in FIG. 16, when tonic water icon 15 is selected from the plurality of icons on the first hierarchy, and if images corresponding to the plurality of items on the second hierarchy are shown to right of tonic water icon 15, in a similar or identical manner in the first exemplary embodiment where cola icon 10 is selected from the plurality of icons on the first hierarchy, the images might protrude from the screen of touch panel 5. To prevent this problem, display device 100 according to this exemplary embodiment is configured such that controller 6 causes touch panel 5 to automatically show, in a vacant area of touch panel 5, the plurality of icons on the second hierarchy.

As shown in FIG. 16, when controller 6 determines that a user has touched and selected tonic water icon 15 on the screen shown with the images corresponding to the plurality of items on the first hierarchy as shown in FIG. 3, controller 6 causes touch panel 5 to show, to left of and above tonic water icon 15, the plurality of icons on the second hierarchy, i.e., orange icon 19, lemon icon 18, and grape icon 17.

When controller 6 determines that the user has further selected grape icon 17, controller 6 causes touch panel 5 to show, above grape icon 17, the plurality of icons on the third hierarchy, i.e., cup size icons (size S icon 22, size M icon 23, and size L icon 24).

As described above, with display device 100 and the display method for display device 100, according to this exemplary embodiment, when a user has selected an image corresponding to an item from a plurality of items shown on touch panel 5, controller 6 causes touch panel 5 to show in a vacant area (an area where neither an icon nor a similar object is shown) in a screen of touch panel 5 a plurality of icons (images) on a lower hierarchy. According to such a configuration and a display method, a plurality of items can effectively be shown in a limited display area of touch panel 5.

Similarly, when a user has selected another icon from the base beverage menu on the first hierarchy, instead of tonic water icon 15, controller 6 causes touch panel 5 to show in a vacant area of touch panel 5 the plurality of items on the second hierarchy. As described above, with display device 100 and the display method for display device 100, according to this exemplary embodiment, a plurality of icons on a lower hierarchy can appropriately be changed in display position, according to a position of an icon selected on touch panel 5.

### Other Exemplary Embodiments

Beverage menus, soda density, and other items set as described above are not limited to the first to seventh exemplary embodiments. In other words, in selecting a beverage menu, display device 100 may be configured such that, in order to cause beverage dispenser 1 to dispense a beverage mixed with at least three beverage menus, at least three hierarchies are set, and images corresponding to a respective plurality of items on the three hierarchies are selected. The display method for display device 100, according to the present disclosure, may include a step of setting at least three hierarchies, and of selecting images corresponding to a respective plurality of items. Display device 100 may be configured such that a setting like “ice or no ice” can be selected in addition to various settings such as soda density. The display method for display device 100, according to the present disclosure, may include a step of allowing a user to set other settings such as “w/or w/o ice” in display device 100.

Circular icons have been used to describe the above described exemplary embodiments. However, icons are not limited to this circular form. For example, icons may be configured to each have a polygonal shape so as to be shown in a honeycomb structure as a whole where icons on a lower hierarchy are shown abut with sides of a polygonal icon selected on an upper hierarchy.

Order, size, and shape of icons are not limited to the above described exemplary embodiments. For example, icons may be arranged and shown on a screen of touch panel 5 in an order of frequency of use. In display device 100, controller 6 may be able to recognize a certain user, and to switch an arrangement of icons shown on a screen of touch panel 5 to an icon arrangement set beforehand for the certain user. A display method for display device 100 may include a step of switching an arrangement of icons shown on a screen of touch panel 5 to an icon arrangement set beforehand for a certain user to show the icons on touch panel 5.

In the above described exemplary embodiments, based on predetermined positions at which the plurality of icons (images) on the first hierarchy will be shown, controller 6 causes touch panel 5 of display device 100 to show the icons on the second hierarchy touched with or adjacent to an icon selected on the first hierarchy. However, the present disclosure is not limited to this display style. For example, based on a desired location (position) touched by a user on touch panel 5, controller 6 may cause touch panel 5 to show the plurality of icons on the first hierarchy, as well as show the plurality of icons on the second hierarchy and a plurality of icons on subsequent hierarchies, adjacent to or touched with the icon selected on the first hierarchy.

In the above described exemplary embodiments, the base beverage menu is shown on the first hierarchy, the flavor mix menu is shown on the second hierarchy, and the cup size menu is shown on the third hierarchy. However, a plurality of hierarchies is not limited in number to three hierarchies, i.e. the first to third hierarchies, but the fourth or higher hierarchies, i.e. n-th hierarchy (n is a natural number), may be provided. In the scope of the claims, a first hierarchy is not limited to the hierarchy, exemplified as the first hierarchy in the above described exemplary embodiments, for selecting an item from the base beverage menu, but the first hierarchy may be the second hierarchy or a desired, subsequent hierarchy (the third hierarchy, for example) in the above described exemplary embodiments.

The initial screen in the above described exemplary embodiments is not limited to the screen showing the plurality of items on the first hierarchy, but may be set as desired.

In the above described exemplary embodiments, icons (images) to be shown on touch panel 5 of display device 100 are reduced in size as a hierarchy lowers (see FIG. 5, for example). However, icons may be shown unchanged (substantially identical) in size in all hierarchies. Icons (images) to be shown on touch panel 5 of display device 100 may otherwise be configured to increase in size as a hierarchy lowers.

In the above described exemplary embodiments, a user makes an entry operation, with his or her finger, on touch panel 5. However, the user may use another body part, instead of the finger, or, may use a pen or a ball-point pen.

In the above described exemplary embodiments, controller 6 is configured to control supply controller 8, beverage supply 9, and other components of beverage dispenser 1, as well as control the display unit and other components of display device 100. However, target components to be controlled by controller 6 are not limited to those components. For example, supply controller 8, beverage supply 9, and other components of beverage dispenser 1, and the display unit and other components of display device 100 may respectively be controlled by separate controllers. In this case, for example, two controllers may be configured to cooperate each other to control necessary components such that, based on a control performed by one of the controllers, the other controller performs a control. Otherwise a central controller for controlling two controllers may additionally be disposed on a device equipped with display device 100.

In the above described exemplary embodiments, display device 100 and the display method for display device 100, according to the present disclosure, have been described using a device for dispensing a beverage (beverage dispenser 1). However, such a display device and a display method for the display device are not limited to using beverage dispenser 1. Technical ideas of the present disclosure may be applicable to such a device equipped with a display device having at least two hierarchies through which a user is able to select desired items from a plurality of items on the respective hierarchies, and to combine the selected plurality of items to obtain a desired combination. Display device 100 and the display method for display device 100, according to the present disclosure, may be implemented in other electronic devices having a display device, such as ticket vending machines and concert ticket vending machines, televisions and Blu-ray (registered trademark) recorders having a function for performing various settings, personal computers, and refrigerators.

As described above, the present disclosure provides a display device and a display method for the display device capable of performing operations for easily and promptly selecting desired items from a plurality of items, and for combining the selected items to obtain a desired combination. The present disclosure can therefore be widely applicable, in addition to beverage dispensers, in other electronic devices and appliances having a display device, such as ticket vending machines and concert ticket vending machines, televisions and Blu-ray (registered trademark) recorders having a function for performing various settings, personal computers, and refrigerators.

What is claimed is:

1. A display device comprising:
a display unit;
a storage unit for storing a plurality of images to be shown on the display unit;
an input unit for accepting an entry operation for selecting at least one of the plurality of images to be shown on the display unit; and
a controller for selecting, from the plurality of images, based on the entry operation on the input unit, at least one image to be shown on the display unit, and for causing the display unit to show the selected at least one image,
wherein
the storage unit further stores menu information including a plurality of hierarchies and a plurality of items set in each of the plurality of hierarchies, the plurality of images include images respectively corresponding to the plurality of items set in each of the plurality of hierarchies included in the menu information, and
the controller causes the display unit to show, when the controller determines that an item is selected from the plurality of items set in an n-th hierarchy (n is a natural number) in the plurality of hierarchies included in the menu information, an image corresponding to the item selected on the n-th hierarchy, in a mode indicating that the item is selected, and images respectively corresponding to the plurality of items on a hierarchy lower than the n-th hierarchy, around the image corresponding to the item selected on the n-th hierarchy.

2. The display device according to claim 1, wherein, in a case where the hierarchy lower than the n-th hierarchy is an (n+1)-th hierarchy among the plurality of hierarchies, when the controller determines that an image is selected from the images respectively corresponding to the plurality of items on the (n+1)-th hierarchy, the controller causes the display unit to show the selected image, in a mode indicating that the image is selected, and further show images respectively corresponding to the plurality of items on an n+2-th hierarchy lower than the (n+1)-th hierarchy, around the image selected on the (n+1)-th hierarchy.

3. The display device according to claim 1, wherein, when the controller determines that an image is selected through the entry operation on the input unit, from the images respectively corresponding to the plurality of items set in the n-th hierarchy in the plurality of hierarchies, the controller causes the display unit to show the selected image, in a mode indicating that the image is selected, and images respectively corresponding to the plurality of items on the (n+2)-th hierarchy which is lower than the n-th hierarchy, around the image selected on the n-th hierarchy, and, when the controller determines that an image is selected from the images respectively corresponding to the plurality of items on the (n+2)-th hierarchy, the controller automatically selects a predetermined item on the (n+1)-th hierarchy and causes the display unit to show an image corresponding to the predetermined item.

4. The display device according to claim 3, wherein the predetermined item to be selected automatically by the controller on the (n+1)-th hierarchy is set beforehand and stored in the storage unit.

5. The display device according to claim 4, wherein the predetermined item to be selected automatically by the controller on the (n+1)-th hierarchy is associated with the item corresponding to the image selected on the n-th hierarchy and the item corresponding to the image selected on the (n+2)-th hierarchy, is set beforehand, and is stored in the storage unit.

6. The display device according to claim 1, wherein the images respectively corresponding to the plurality of items on the hierarchy lower than the n-th hierarchy are separated into a plurality of pages and stored in the storage unit, and each of the plurality of pages is switched with another of the plurality of pages to be shown on the display unit through a predetermined entry operation on the input unit, and is shown on the display unit.

7. The display device according to claim 1, wherein the controller causes the display unit to show, in different forms, the image corresponding to the item determined by the controller as being selected through the entry operation on the input unit, and the images corresponding to the items determined by the controller as not being selected through the entry operation on the input unit.

8. The display device according to claim 1, wherein the images respectively corresponding to the plurality of items are shown in icons or messages on the display unit, and the icon or message corresponding to the item selected from the plurality of items on the n-th hierarchy is shown, on the display unit, adjacent to or touched with at least parts of the images of the icons or messages regarding the plurality of items on the hierarchy lower than the n-th hierarchy.

9. A display method for a display device including a display unit, a storage unit for storing a plurality of images to be shown on the display unit, an input unit for accepting an entry operation for selecting at least one of the plurality of images to be shown on the display unit, and a controller for selecting, from the plurality of images, based on the entry operation on the input unit, at least one image to be shown on the display unit, and for causing the display unit to show the selected at least one image, wherein the storage unit further stores menu information including a plurality of hierarchies and a plurality of items set in each of the plurality of hierarchies, and the plurality of images include images respectively corresponding to the plurality of items set in each of the plurality of hierarchies included in the menu information, the display method comprising:
showing, on the display unit, the images respectively corresponding to the plurality of items set in an n-th hierarchy (n is a natural number) in the plurality of hierarchies included in the menu information;
showing, on the display unit, the image selected, through the entry operation on the input unit, from the images respectively corresponding to the plurality of items on the n-th hierarchy, in a mode indicating that the image is selected; and
showing the images respectively corresponding to the plurality of items on a hierarchy lower than the n-th hierarchy, around the selected image.

10. The display method for the display device, according to claim 9, further comprising showing, on the display unit, when the hierarchy lower than the n-th hierarchy is an (n+1)-th hierarchy in the plurality of hierarchies, the images respectively corresponding to the plurality of items on an (n+2)-th hierarchy which is lower than the (n+1)-th hierarchy, around the image corresponding to the item selected on the (n+1)-th hierarchy.

11. The display method for the display device, according to claim 10, further comprising automatically showing, on the display unit, when an image is selected from the images respectively corresponding to the plurality of items set on the (n+2)-th hierarchy, a predetermined item on the (n+1)-th hierarchy.

12. The display method for the display device, according to claim 9, further comprising:
showing the images respectively corresponding to the plurality of items set on an (n+1)-th hierarchy which is lower than the n-th hierarchy, around the image corresponding to the item selected on the n-th hierarchy, and
showing each of a plurality of pages into which the images respectively corresponding to the plurality of items on the (n+1)-th hierarchy are separately stored, by switching each of the plurality of pages through a predetermined entry operation on the input unit.
